(19) United States
(12) Patent Application Publication
(10) Pub. No.: US 2019/0063115 A1
(43) Pub. Date: Feb. 28, 2019

(54) U-LOCK WITH NOVEL CROSS-SECTIONAL SHAPE

(71) Applicant: Ino Vision Ltd., Herzliya (IL)

(72) Inventor: Michael Shenkerman, Rishpon (IL)

(73) Assignee: Ino Vision Ltd., Herzliya (IL)

(21) Appl. No.: 16/059,195

(22) Filed: Aug. 9, 2018

Related U.S. Application Data
(60) Provisional application No. 62/551,235, filed on Aug. 29, 2017.

(51) Int. Cl. E05B 67/06

(52) U.S. Cl. CPC E05B 67/063

(57) ABSTRACT

A U-lock including a U-shaped shackle that includes two legs extending from a bow, the legs being received in a locked orientation in apertures formed in a crossbar, and a lock mechanism coupled to the crossbar for locking the legs with the crossbar. At least one of the legs and the bow of the U-shaped shackle has a cross-sectional shape of a polygon which has flat sides and none of the flat sides are parallel to each other.

### FIELD OF THE INVENTION

The present invention generally relates to locks, and particularly to a U-lock with novel cross-sectional shapes.

### BACKGROUND OF THE INVENTION

U-locks are commonly used for locking a bicycle, motorcycle, motorbike, tricycle and the like (the terms being used interchangeably throughout), to prevent theft of the bicycle. Ordinarily, a rider will lock the bicycle frame and at least one wheel to a fixed object or to itself to secure the bicycle.

A U-lock generally includes a U-shaped shackle with two substantially straight and parallel legs coupled to one another by a curved bow, and a removable crossbar. The crossbar in general is a bar which includes two holes for receiving the legs of the shackle. A lock mechanism is fitted in the crossbar for securing the crossbar to the U-shaped shackle.

In the prior art, the U-shaped shackle is made of metal bar, which has a circular cross-sectional shape, formed into a U-shape.

To lock a bicycle to a post or other object, the ends of the U-shaped shackle are passed around the post and a portion of the frame and/or one tire (or both) of a bicycle and secured by the crossbar.

### SUMMARY OF THE INVENTION

The present invention seeks to provide a U-lock with a non-circular cross-sectional shape, as is described more in detail hereinbelow.

There is thus provided in accordance with an embodiment of the present invention a U-lock including a U-shaped shackle that includes two legs extending from a bow, the legs being received in a locked orientation in apertures formed in a crossbar, and a lock mechanism coupled to the crossbar for locking the legs with the crossbar, wherein at least one of the legs and the bow of the U-shaped shackle has a cross-sectional shape of a polygon which has flat sides and none of the flat sides are parallel to each other.

For example, the legs and the bow may all have the cross-sectional shape of the polygon. As another example, only both of the legs may have the cross-sectional shape of the polygon. As yet another example, only the bow may have the cross-sectional shape of the polygon. The cross-sectional shape of the polygon may extend over the entire length of the legs or only a portion thereof.

### BRIEF DESCRIPTION OF THE DRAWINGS

The present invention will be understood and appreciated more fully from the following detailed description taken in conjunction with the drawings in which:

FIG. 1 is a simplified illustration of a U-lock, constructed and operative in accordance with a non-limiting embodiment of the present invention; and

FIGS. 2, 3, 4 and 5 are simplified sectional illustrations of a cross-sectional shape of the U-shaped shackle of the U-lock, taken along lines A-A in FIG. 1, in accordance with different non-limiting embodiments of the present invention.

### DETAILED DESCRIPTION OF EMBODIMENTS

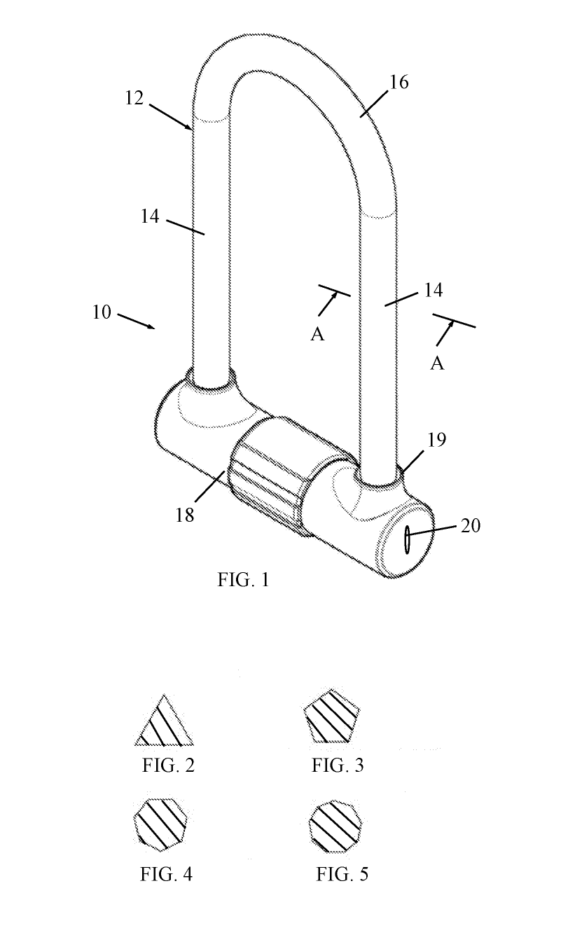

Reference is now made to FIG. 1, which illustrates a U-lock 10, in accordance with a non-limiting embodiment of the present invention.

U-lock 10 includes a U-shaped shackle 12 that includes two legs 14 extending from a bow 16. It is noted that the U-shape does not only include a “U” which has a curved bow, but also includes other shapes, such as but not limited to, a straight bow, bent bow and others. Legs 14 may be straight but may also be curved or bent or other shapes. Legs 14 may be hollow or solid with no voids.

Legs 14 are received in a locked orientation in apertures 19 formed in a crossbar 18. A lock mechanism 20 is coupled to crossbar 18 for locking legs 14 with crossbar 18. The lock mechanism 20 may be, without limitation, a cylinder lock, a combination lock, a wireless communication lock (that operates with a transponder that communicates with identification circuitry in the lock to gain authorized access to the lock), such as an RFID lock, NFC lock, Bluetooth lock, Wi-Fi lock, mobile device, and others. Other locking types can also be used.

As seen in FIGS. 2-5, at least one of legs 14 and bow 16, and any combination thereof, of U-shaped shackle 12 may have a cross-sectional shape of a polygon which has flat sides and none of the flat sides are parallel to each other. In FIG. 2, the polygon is a triangle (may be equilateral, isosceles, or other). In FIG. 3, the polygon is a pentagon (5 sides). In FIG. 4, the polygon is a heptagon (7 sides). In FIG. 5, the polygon is a nonagon (9 sides). The corners at adjoining sides may be sharp or rounded.

The feature of the cross-sectional shape of a polygon which has flat sides with none of the flat sides being parallel to each other has several advantages. First, because none of the flat sides are parallel to each other, a wrench cannot be used to grasp the shackle 12. Second, the polygonal shape may have better stiffness than a circular cross-sectional shape for the same cross-sectional area.

For example, in the article, “Circular vs triangular cross sections: some thoughts about bending stiffness”, Johan Byström and Leonid Kuzmin, page 5, (which can be seen at http://www.kuzmin.se/docs/buckling_of_ski_pole_2013.pdf), it is stated:

“Hence a solid triangular cross section is 21% stiffer than a solid circular cross section with the same cross section area.”

The U-lock 10 may be made of any suitably strong and durable material, as is known in the bicycle lock art.

What is claimed is:

1. A lock comprising:
a U-lock comprising a U-shaped shackle that comprises two legs extending from a bow, said legs being received in a locked orientation in apertures formed in a crossbar; and
a lock mechanism coupled to said crossbar for locking said legs with said crossbar, wherein at least one of said legs and said bow of said U-shaped shackle has a cross-sectional shape of a polygon which has flat sides and none of the flat sides are parallel to each other.

2. The lock according to claim 1, wherein said polygon comprises a triangle.

3. The lock according to claim 1, wherein said polygon comprises a pentagon.

4. The lock according to claim 1, wherein said polygon comprises a heptagon.

5. The lock according to claim 1, wherein said polygon comprises a nonagon.

6. The lock according to claim 1, wherein said legs and said bow all have said cross-sectional shape of said polygon.

7. The lock according to claim 1, wherein both of said legs have said cross-sectional shape of said polygon.

8. The lock according to claim 1, wherein said bow has said cross-sectional shape of said polygon.
